(19) United States
(12) Patent Application Publication
(10) Pub. No.: US 2005/0279801 A1
(43) Pub. Date: Dec. 22, 2005

(54) Adhesive tape roll with add-on cutter device and combined pull tape-end

(76) Inventor: Po-Wei Chien, Taipei (TW)

Correspondence Address: Po-Wei Chien, P. O. Box No. 6-57, Junghe, Taipei, 235, TW

(21) Appl. No.: 10/868,883

(22) Filed: Jun. 17, 2004

(51) Int. Cl. B26F 3/02

(52) U.S. Cl. 225/91; 225/58

(57) ABSTRACT

An adhesive tape roll with add-on cutter device and combined pull tape-end embodying a reel form adhesive tape roll, and characterized in that a cutting element is attached to a pull-end of adhesive tape, thereby forming the adhesive tape roll combined with the cutting element, wherein a severing portion configured on the cutting element is able to pierce and sever the adhesive tape. Hence, the cutting element forms both the pull-end of the adhesive tape, and when using the adhesive tape to adhere to an object, a severing portion of the cutting element effectuates a cutting action on the adhesive tape, thus the cutting element proffers dual effectiveness of providing the pull-end and the cutting action.

### BACKGROUND OF THE INVENTION

(a) Field of the Invention

The present invention provides an adhesive tape roll with add-on cutter device and combined pull tape-end, and more particularly to the cutting element that forms both the tape pull-end of the adhesive tape roll and, when using the adhesive tape to adhere to an object, a severing portion of the cutting element effectuates a cutting action on the adhesive tape, thus the cutting element proffers dual effectiveness of providing the pull-end and the cutting action.

(b) Description of the Prior Art

A paper strip is necessarily attached to a front end of adhesive tape of a conventional adhesive tape roll in order to prevent an adhesive surface of the front end of the adhesive tape to adhere directly to a surface of the adhesive tape roll, and thus facilitates a person in pulling the adhesive tape end with a hand.

However, after long-term usage of such conventional art for the adhesive tape roll following shortcomings are apparent:

(1) Each time the adhesive tape roll is used by a user, because the paper strip is necessarily attached to the adhesive surface of the front end of the adhesive tape in order to prevent the adhesive surface from adhering to the surface of the adhesive tape roll, thus, after every use of the adhesive tape the paper strip must be looked for, and therefore clearly annoying and inconvenient.

(2) When using a stand-alone adhesive tape to adhere to a surface of an object, a cutting tool must still be necessarily sought or carried on one's person in order to cut the adhesive tape. Hence, because the cutting tool is necessarily sought each time the adhesive tape is used, extreme inconvenience is clearly apparent.

Accordingly, subject of the present invention is to make a thorough study on how to proffer the adhesive tape roll with double effectiveness that provides both a pull-end on an end portion of the adhesive tape when not being used to adhere to an object, and moreover, effectuates cutting of the adhesive tape when being used to adhere the adhesive tape to the object.

### SUMMARY OF THE INVENTION

A primary objective of the present invention is to provide an adhesive tape roll with add-on cutter device and combined pull tape-end, whereby a cutting element can be pre-attached to an end portion of a reel form adhesive tape roll, therewith forms a pull-end for the adhesive tape for when using the adhesive tape to adhere to an object, moreover, a severing portion of the cutting element effectuates a cutting action on the adhesive tape. Hence, the cutting element proffers dual effectiveness of providing the pull-end and the cutting action.

Referring to FIG. 9, which shows the present invention provides the adhesive tape roll with add-on cutter device and combined pull tape-end comprising:

The reel form adhesive tape roll 10 characterized in that a cutting element 20 is attached to a pull-end 15 of adhesive tape 17, thereby forming the adhesive tape roll 10 combined with the cutting element 20, and wherein a severing portion 22 configured on the cutting element 20 is able to pierce and sever the adhesive tape 17.

The cutting element 20 assumes an arc-shaped form, and an adhesive surface 151 of the adhesive tape pull-end 15 of the adhesive tape roll 10 is adhered to a surface 23 of the cutting element 20.

Referring to FIGS. 1 and 2, wherein the severing portion 22 of the cutting element 20 assumes a serrated form, and is configured on a side edge of the cutting element 20.

Referring to FIG. 37 wherein the severing portion 22 assumes a serrated, sharp-body form, and is configured on the surface 23 of the cutting element 20.

Referring to FIG. 2, wherein the severing portion 22 is fabricated from a metal piece 221. The metal piece 221 is fixedly connected to the side edge of the cutting element 20.

Referring to FIG. 7, wherein the metal piece 221 defined with the severing portion 22 is fixedly connected to a front edge of the cutting element 20. Ear portions 27 are separately configured on each side of the cutting element 20, and clasp protrusions 271 are separately configured on each of the ear portions 27. The two protrusions 271 clasp side edges 13 of the adhesive tape roll 10 (see FIG. 8).

Referring to FIG. 12, wherein the severing portion 22 assumes a sharp plate, and which is fabricated from a sharp body and sand grains.

Referring to FIG. 1, wherein the cutting element 20 and the severing portion 22 are formed from single body.

Referring to FIG. 14, wherein the cutting element 20 is attached within a central core 19 of the adhesive tape roll 10.

The severing portion 22 is fabricated from a sharp body.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows an elevational view of a cutting element according to the present invention.

FIG. 2 shows an elevational view of another embodiment of the cutting element according to the present invention.

FIG. 3 shows an elevational view of yet another embodiment of the cutting element according to the present invention.

FIG. 4 shows an exploded elevational view of yet another embodiment of the cutting element according to the present invention.

FIG. 5 shows an assembled elevational view of the embodiment of the cutting element as depicted in FIG. 4 according to the present invention.

FIG. 6 shows a sectional view according to the present invention.

FIG. 7 shows an elevational view of yet another embodiment of the cutting element according to the present invention.

FIG. 8 shows a sectional view of the cutting element positioned on an adhesive tape roll according to the present invention.

FIG. 9 shows an exploded elevational view according to the present invention.

FIG. 10 shows an elevational motion diagram of the cutting element cutting adhesive tape according to the present invention.

FIG. 11 shows an elevational motion diagram of the cutting element after severing the adhesive tape according to the present invention.

FIG. 12 shows an elevational view of yet another embodiment of the cutting element according to the present invention.

FIG. 13 shows an elevational motion diagram of the cutting element severing the adhesive tape according to the present invention.

FIG. 14 shows an elevational motion diagram of the cutting element being positionally clasped within a central core of the adhesive tape roll according to the present invention.

### DETAILED DESCRIPTION OF THE PREFERRED EMBODIMENTS

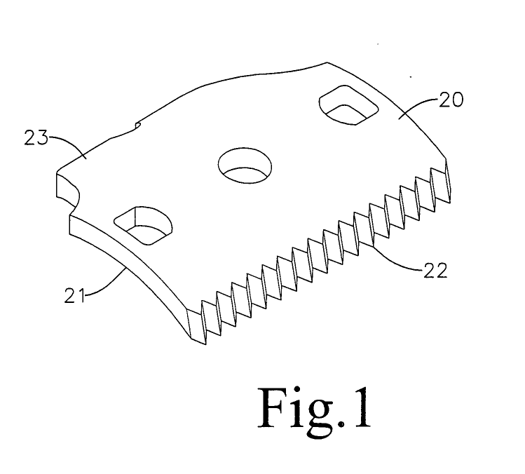

Referring to FIG. 1, which shows a cutting element 20 of the present invention. The cutting element 20 assumes an arc-shaped form, and a severing portion 22 is configured on a lower edge of the cutting element 20. The severing portion 22 forms an integrated body with the cutting element 20, with the severing portion 22 assuming a serrated form.

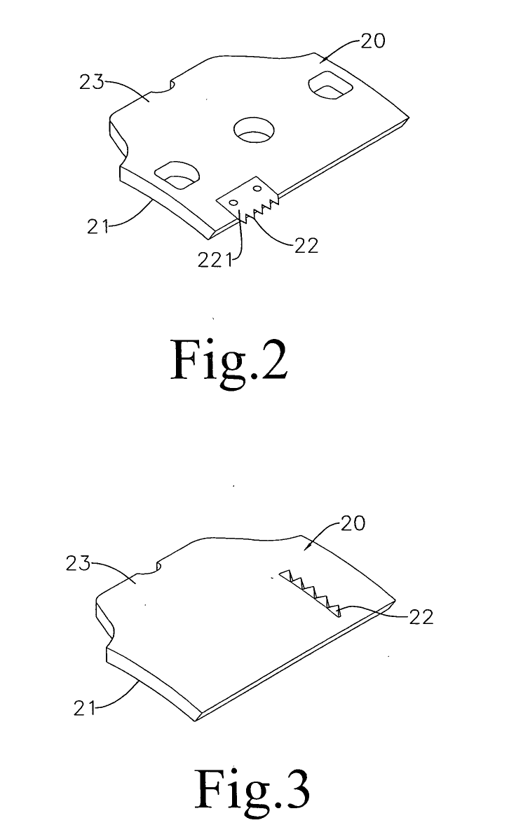

Referring to FIG. 2, which shows the severing portion 22 fabricated from a metal piece 221, and which is fixedly connected to a partial segment of a lower edge of the cutting element 20. With such a configuration, the severing portion 22 forms a relatively small area of the cutting element 20.

Referring to FIG. 3, which shows that the severing portion 22 of the present invention can also be configured on a surface 23 of the cutting element 20.

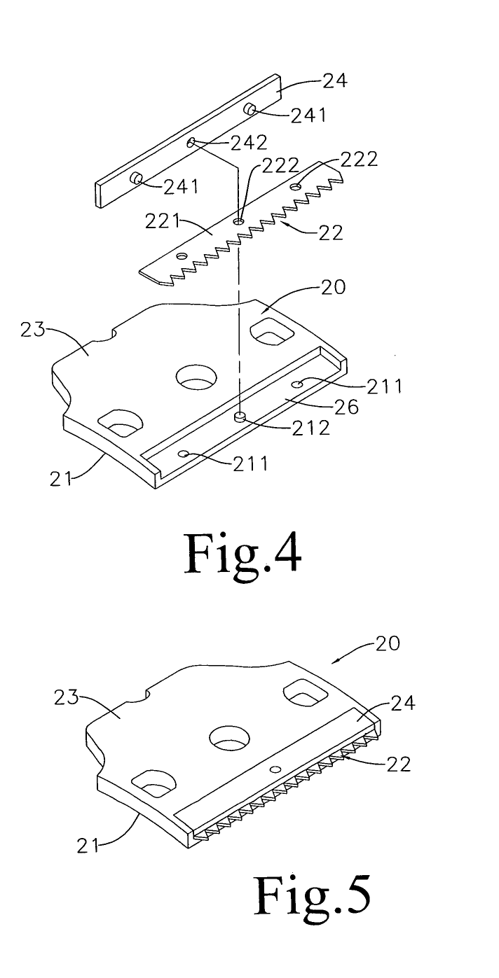

Referring to FIG. 4, which shows a body of the severing portion 22 of the cutting element 20 of the present invention fabricated from the metal piece 221, and having a relatively large surface area. Pin connecting holes 222 are defined in the metal piece 221. A rabbet 26 is configured in a lower edge of the cutting element 20, and connecting holes 211 and a pin 212 are configured on the rabbet 26. Pins 241 and a connecting hole 242 are configured on a pressure plate 24. The pins 241 penetrate the pin connecting holes 222 of the metal piece 221 and insert into the connecting holes 211 of the rabbet, while the pin 212 of the rabbet penetrates the connecting hole 222 of the metal piece 221 and inserts into the connecting hole 242 of the pressure plate 24, thus the metal piece 221 is fixedly configured atop the cutting element 20 (see FIG. 5).

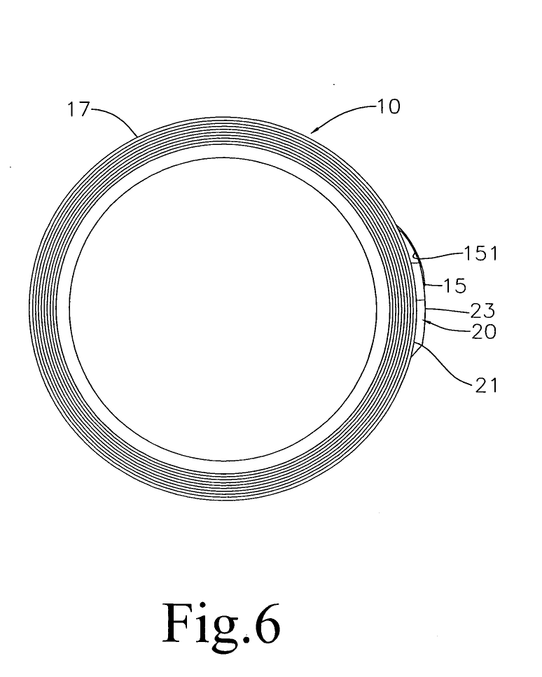

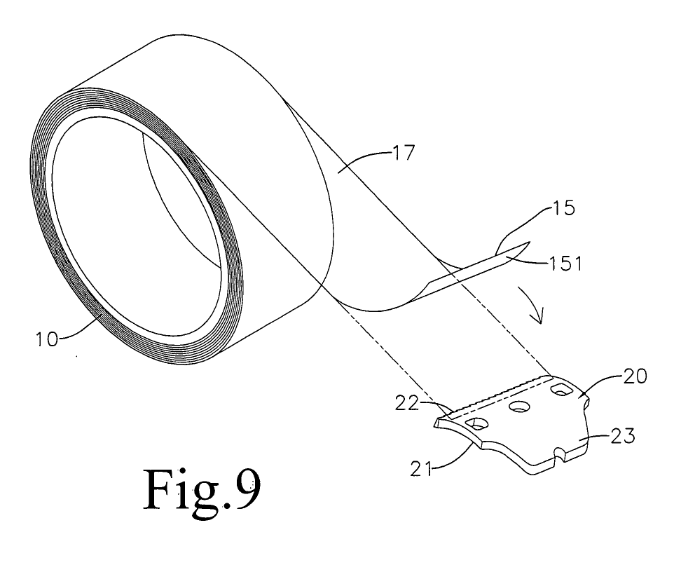

Referring to FIGS. 6 and 9, an adhesive surface 151 of a pull-end 15 of an adhesive tape roll 10 is adhered to the top surface 23 of the cutting element 20. A bottom arc-shaped surface of the cutting element 20 coincides with and affixes to a top arc-shaped surface 12 of the adhesive tape roll 10, thus enabling the cutting element 20 to attach to the top surface 12 of the adhesive tape roll 10, and moreover, forms a pull-end for the adhesive tape roll 10.

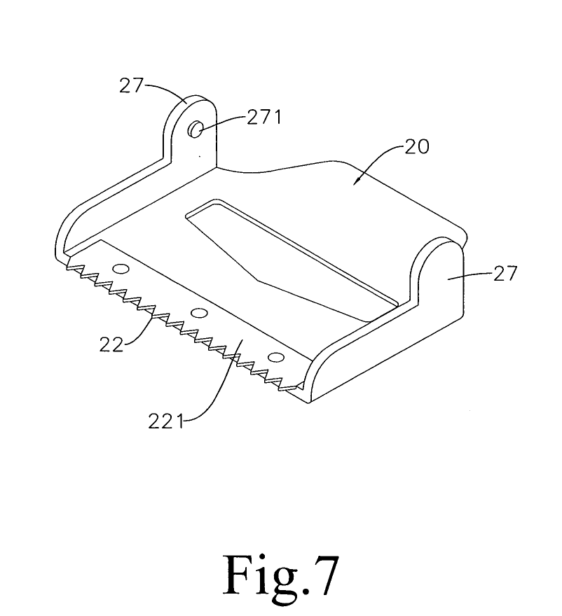

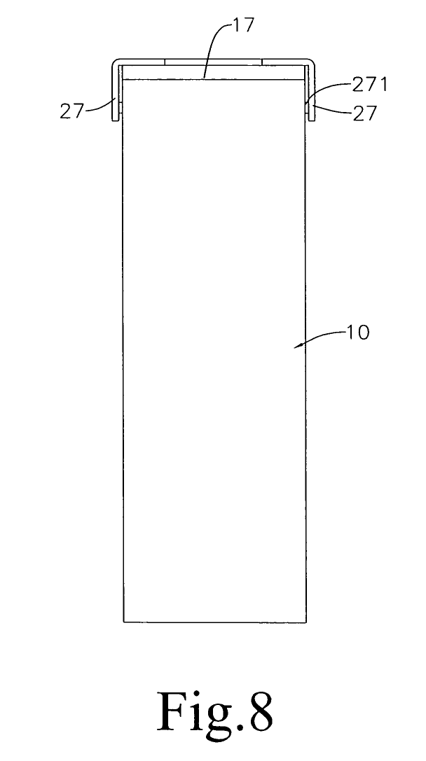

Referring to FIGS. 7 and 8, which show another embodiment of the cutting element 20. Each of two sides of the cutting element 20 assume a form of a longitudinal ear portion 27, and clasp protrusions 271 are configured to clasp side edges 13 of the adhesive tape roll 10. A user needs only raise and outwardly pull the cutting element 20 to easily separate the cutting element 20 from the adhesive tape roll 10, thereby providing usage for cutting of adhesive tape 17.

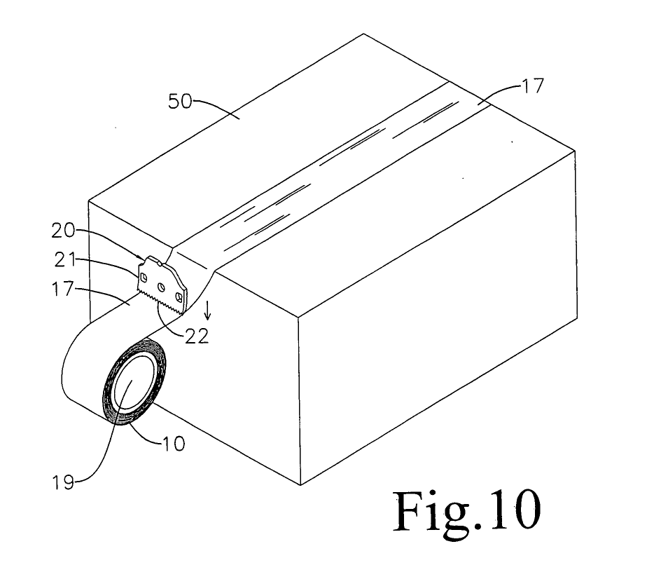

Referring to FIG. 10, which shows a motion diagram depicting a cardboard box 50 being taped up with the adhesive tape 17, and the severing portion 22 of the cutting element 20 being directed towards the adhesive tape 17 and proceeding with severing of the adhesive tape 17 therewith.

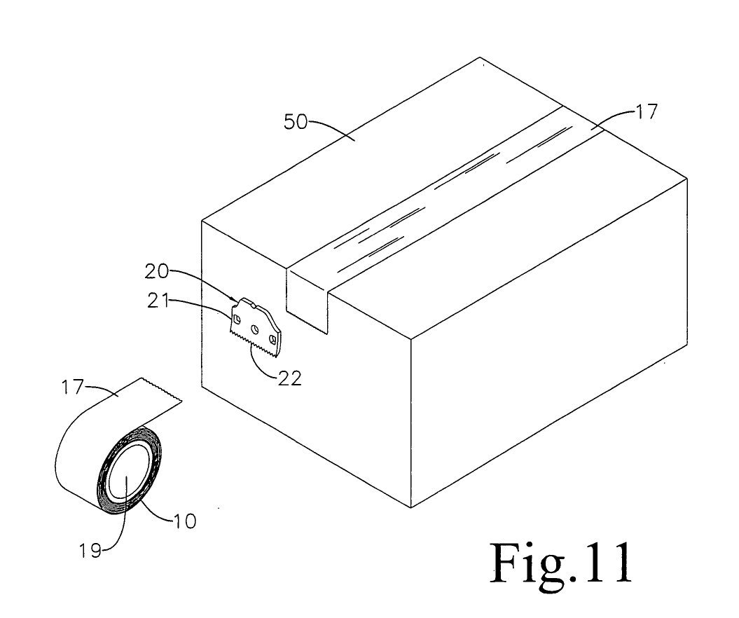

Referring to FIG. 11, which shows the severing portion 22 after severing of the adhesive tape 17 has been completed, thereby achieving realization of the cutting element 20 being used as a tool to sever the adhesive tape 17.

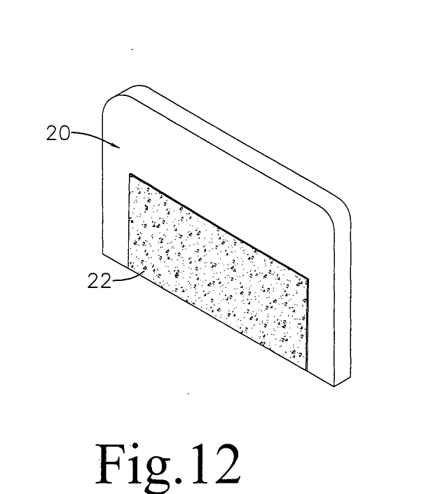

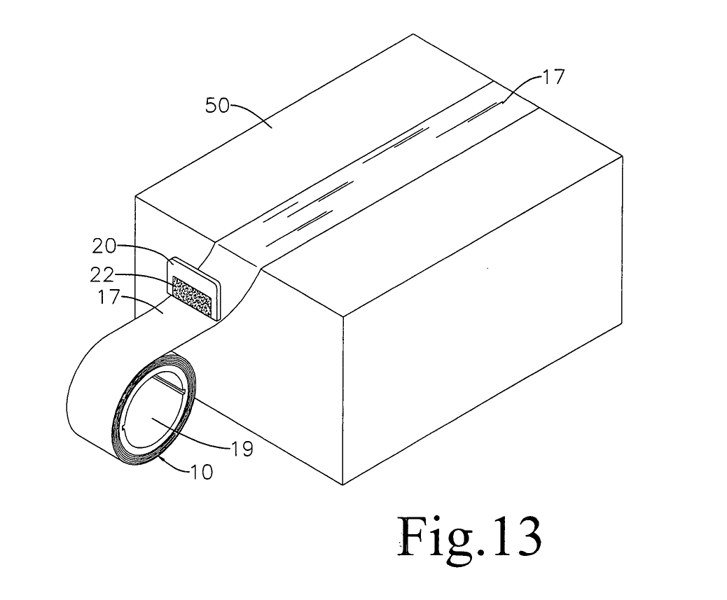

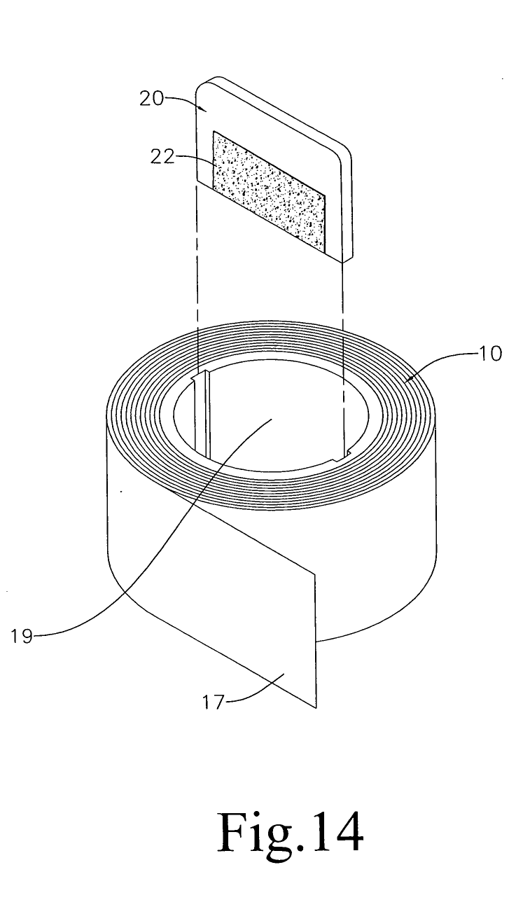

Referring to FIG. 12, which shows the severing portion 22 of the cutting element 20 also configured to assume a sharp form plate. The sharp form plate is fabricated from a sharp body and sand grain (for instance, sandpaper). Referring to FIG. 13, force is applied to the sharp body of the severing portion 22 atop the adhesive tape 17, which thereby actuates functionality of severing and cutting the adhesive tape 17. Referring to FIG. 14, which shows a preferred embodiment of the present invention, whereby the cutting element 20 of the present invention can be further attached or clasped within the central core 19 of the adhesive tape roll 10.

In conclusion, the cutting element 20 of the present invention is attached atop the adhesive tape roll 10. When a consumer purchases the adhesive tape roll 10, the attached cutting element 20 can be immediately utilized for cutting adhesive tape, moreover, the cutting element 20 not only actualizes effectiveness of pulling up of the pull-end 15 of the adhesive tape roll 10, but also achieves usage as a cutter of the adhesive tape 17. With such a configuration, the present invention is assuredly provided with novelty and advancement.

It is of course to be understood that the embodiments described herein is merely illustrative of the principles of the invention and that a wide variety of modifications thereto may be effected by persons skilled in the art without departing from the spirit and scope of the invention as set forth in the following claims.

1. An adhesive tape roll with add-on cutter device and combined pull tape-end comprising:
a reel form adhesive tape roll, characterized in that a cutting element is attached to a pull-end of adhesive tape, thereby forming the adhesive tape roll combined with the cutting element, and wherein a severing portion configured on the cutting element is able to pierce and sever the adhesive tape.

2. The adhesive tape roll with add-on cutter device and combined pull tape-end according to claim 1, wherein the cutting element assumes an arc-shaped form, and an adhesive surface of the adhesive tape pull-end of the adhesive tape roll is adhered to a surface of the cutting element.

3. The adhesive tape roll with add-on cutter device and combined pull tape-end according to claim 1, wherein the severing portion of the cutting element assumes a serrated form, and is configured on a side edge of the cutting element.

4. The adhesive tape roll with add-on cutter device and combined pull tape-end according to claim 1, wherein the severing portion assumes a serrated, sharp-body form, and is configured on the surface of the cutting element.

5. The adhesive tape roll with add-on cutter device and combined pull tape-end according to claim 1, wherein the severing portion can be fabricated from a metal piece, and the metal piece is fixedly connected to the side edge of the cutting element.

6. The adhesive tape roll with add-on cutter device and combined pull tape-end according to claim 1, wherein the metal piece defined with the severing portion is fixedly connected to a front edge of the cutting element, and ear portions are separately configured on each side of the cutting element, moreover, clasp protrusions are separately configured on each of the ear portions.

7. The adhesive tape roll with add-on cutter device and combined pull tape-end according to claim 1, wherein the severing portion assumes a sharp plate, and which can be fabricated from a sharp body and sand grains.

8. The adhesive tape roll with add-on cutter device and combined pull tape-end according to claim 1, wherein the cutting element and the severing portion can be formed from single body.

9. The adhesive tape roll with add-on cutter device and combined pull tape-end according to claim 1, wherein the cutting element can be attached within a central core of the adhesive tape roll.

10. The adhesive tape roll with add-on cutter device and combined pull tape-end according to claim 1, wherein the severing portion is fabricated from a sharp body.
